(19) United States
(12) Patent Application Publication
(10) Pub. No.: US 2018/0292038 A1
(43) Pub. Date: Oct. 11, 2018

(54) A CUTTING TOOL AND A BRANCH CONNECTION DEVICE COMPRISING A CUTTING TOOL

(71) Applicant: Wavin B.V., Zwolle (NL)

(72) Inventors: Michiel Heersema, Groningen (NL); Hendrik Jan Mark van der Worp, Zwolle (NL)

(73) Assignee: Wavin B.V., Zwolle (NL)

(21) Appl. No.: 15/767,954

(22) PCT Filed: Oct. 14, 2016
(86) PCT No.: PCT/EP2016/074727

§ 371 Date: Apr. 12, 2018

(30) Foreign Application Priority Data
Oct. 15, 2015 (NL) 1041522

(51) Int. Cl. F16L 41/06; B23B 51/00; F16L 47/34

(52) U.S. Cl. CPC F16L 41/06; B23B 51/00; F16L 47/345; B23B 2215/72; B23B 2270/30; B23B 2226/61; B23B 2251/082; B23B 2251/201; B23B 2251/50; B23B 2222/80

(57) ABSTRACT

A cutting tool for cutting a hole into a fluid transportation pipe and for retaining a cutting chip is provided. The tool (1) comprises a main body (2) having an end which is prolonged by a tapered part (3), the tool (1) further comprising an accommodation space (11), the tool being configured to receive a cutting chip in the accommodation space (11) via an opening (10) which extends at least from a geometrical apex (5) of the tapered part (3) to the periphery of the main body (61), and the tool (1) further has a cutting edge (4) extending at least from the geometrical apex (5) of the tapered part (3) to the periphery of the main body (2) of the cutting tool (1). The main body (2) is made of a material that differs from a material of which the cutting edge (4) is made.

It is desirable to be able to branch off an additional pipe from a pipe transporting a fluid, which is already in use. It is especially desirable to avoid an interruption of the fluid transportation and, for example, having to depressurize the pipe in use, in order to implement a branching point at a selected location. Application examples, where the branching off of a further pipe may be of particular interest, include hard plastic pipes used to transport gas or e.g. water in contemporary water transportation systems.

It is known to use a cutting tool for producing a hole in a pipe whilst the pipe is in use for conducting a fluid. The material cut out from the pipe may at least partially end up as cutting chips. The cutting chips are either flushed away through the pipe in use, i.e. with the fluid being transported in the pipe, or they may be collected and disposed.

To perform the branching off of an additional pipe, a branch connection device, also referred to as a T-shaped coupling element or saddle, may be mounted to a pipe in use at a selected position. A cutting tool may be removably provided in the branch connection device, in order to perform the cutting. After the cutting process, the cutting tool is removed and may be reused. The branch connection device remains positioned as a coupling element between the pipe in use and the additional pipe.

EP 0 622 144 B1 discloses a cutting tool which allows the prevention of an unwanted scattering of cutting chips by being able to peel-off the cutting chip in one or several lengthy pieces and collecting them in the cutting tool. The cutting tool comprises a cylindrical body made of steel and comprising a central recess configured to collect a cutting chip. The cylindrical body is prolonged by a cone with a central cone axis extending parallel and off-center to the central axis of the cylindrical body. The cone is provided with an opening, forming a cutting edge at its periphery. A cutting chip can be caught in the central recess through the opening. This known cutting tool further comprises a window for accessing the central recess, to remove collected cutting chip, i.e. for emptying the central recess, in order to prepare the cutting tool for its next use.

Moreover, EP 0 580 222 B1 discloses a branch connection device for a thermoplastic pipe. This branch connection device comprises a T-shaped connection element and a lateral branching connection member, wherein the T-shaped connection element comprises a lid at one end portion. The lid can be opened to insert a cutting tool into the branch connection device and, after the cutting process has taken place, to withdraw the cutting tool. The lid can be closed, to seal the branch connection device after withdrawing a cutting tool after use.

The known techniques successfully allow branching-off pipes from a fluid transportation pipe which is installed in place and which transports a fluid during the process of installation of the branching point. However, the process of branching off a pipe is rather time-consuming. In addition, the production and use of necessary tools such as the cutting tool and the branch connection devices may be rather costly.

Aside thereof, it remains important to avoid having a cutting chip in an installed fluid transportation pipe, in order to prevent contamination or clogging of the piping system. Therefore, it appears important to be able to effectively and completely collect all of the produced cutting chips. It is also an aim to avoid unintentional plastic deformations of an installed pipe during a cutting process which might smear out the pipe material and, hence, lead to extra fluid flow noises and to a pressure drop in the installed pipe.

It is an object of the present invention to provide a cutting tool, a cutting blade for a cutting tool, and a branch connection device, which promote a higher efficiency for branching off a pipe from a fluid transportation pipe in use, such as e.g. a hard plastic pipe, and which allow cost-efficient branching off processes.

Embodiments of the present invention are defined by the claims below.

According to one aspect of the present invention, a cutting tool for cutting a hole into a fluid transportation pipe and for retaining a cutting chip comprises a main body having an end which is prolonged by a tapered part. The tool also comprises an accommodation space, and it is configured to receive a cutting chip in the accommodation space via an opening which extends at least from a geometrical apex of the tapered part to the periphery of the main body. The tool further comprises a cutting edge extending at least from the geometrical apex of the tapered part to the periphery of the main body of the cutting tool. In addition, the main body is made of a material that differs from a material of which the cutting edge is made.

The cutting edge is configured to cut off a part of one or several layers of a fluid transportation pipe, for example a hard plastic pipe adapted to transport a gas or a liquid such as water. In this regard, the term ‘cutting off’ may also include penetrating a part of a layer of a pipe to be cut with the cutting edge. This penetration serves the purposes of starting a cut and may include piercing, drilling and/or milling in the sense of being a superposition of boring and cutting. In addition, the term ‘cutting off’ may also be understood to include the peeling off of a layer.

Due to the presence of the cutting edge, extending from the geometrical apex of the tapered part to the periphery of the cylindrical body of the cutting tool, the cutting edge of the tool may be guided along one or several layers of the pipe and cut, peel, and/or scrape off a lengthy cutting chip. This prevents the generation of a plurality of (smaller) bits of cutting chips. It may even promote generating a single cutting chip. The generation of lengthy cutting chip also prevents such cutting chips from being scattered, and in particular, it prevents one or several such bits from accidentally entering the fluid stream in a pipe in use, even in a case in which the lengthy cutting chip might be broken into two or several bits during the process of receiving and accommodating the chip in the accommodation space.

The cutting chip received in the accommodation space of the tool. In this way, the cutting chip is prevented from entering into the fluid flowing in the pipe in use which is being processed with the cutting tool. As both the cutting edge and the opening extend at least from the geometrical apex of the tapered part to the periphery of the cylindrical body of the cutting tool, the opening is configured to receive a cutting chip substantially along the entire length of the cutting edge.

The tapered part tapers in an inward direction towards a cutting end of the tool, i.e. towards a central longitudinal axis of the tool. This allows easily cutting a layer of a fluid transportation pipe. The tapered part may be shaped symmetrically or anti-symmetrically, and a central axis of the tapered part may extend parallel or obliquely with regard to a central axis of the main body of the tool.

Preferably, also the tapered part is made of a material that differs from the material of which the cutting edge is made. The materials of the tapered part and of the main body can be the same material or they can be mutually different materials.

Making the cylindrical body and the cutting edge of different materials allows optimizing the technical performance of the cutting tool in a number of ways. For example, it allows manufacturing the main body from a material which prevents corrosion. In addition, the cutting tool can be made lighter due to making the main body of a light material. The main body can also be made from a material which is easy to shape, such that one can easily implement rounded edges in the interior of the opening and/or the accommodation space, so as to prevent any jaggy parts which might promote the breaking of a cutting chip. Moreover, one can choose a material for the main body which allows reducing the manufacturing costs, as the materials of the two parts can be cost-optimized with regard to their technical purposes. On the one hand, the cutting edge can be made from a material which satisfies the hardness (and other) requirements needed to be able to cut the layer(s) of a fluid transportation pipe. On the other hand, the cylindrical body can be made from a different material, which may, for example, be cheaper than the material of the cutting edge, and which may be particularly suited to be retained in a pipe joint over an extended period of time.

Due to the selective choice of material of the cylindrical body and the cutting edge, which serve different technical purposes, the material costs may be reduced. It is therefore further possible to design the cutting tool as a cutting tool for single use, i.e. as a cutting tool which can remain in a branch connection device after use. This eliminates the need of removing the cutting tool after use.

The cutting tool may be designed to store the cutting chip in the accommodation space long term, so that there is no need for disposal. Long term may, in this context, mean several weeks, months or years (for example, 10, 20 or 50 years). Alternatively, it may mean until the next maintenance of the point joint in which a cutting tool with the cutting chip is retained. The storing of the cutting chip in a cutting tool remaining in the pipe joint promotes a higher efficiency of the process of branching off of a pipe, as a cutting tool can then simply be left in a storage position of a branch connection device where it shields off and holds the cutting chip for an extended period of time (e.g. for 50 years). This period of time may depend on the layout of the materials and the technical requirements to be met by the pipes used.

The cutting edge preferably has a leading portion, extending to a position close to the geometrical apex of the tapered part of the main body, a trailing portion, and a transition portion, located between the leading portion and the trailing portion. The transition portion is for effecting a separation between a cutting chip and a pipe being cut. Moreover, the transition portion has a curved shape.

The transition portion having a curved shape means that the transition portion is free from an angularity, i.e. free from an angular transition point. In other words, the transition portion may be understood to be a rounded portion. The outermost point of the transition portion may also be the outermost portion of the cutting edge, so that the curved shape is a convex shape when viewed from outside of the tool.

The transition portion is located such that it is the part of the cutting edge which is involved when performing the part of the cutting during which the separation of a cutting chip from a pipe takes place. Preferably, the separation is a final separation, i.e. the separation wherein the cutting chip is finally split off from the pipe, similar to separating an integral piece of peel from an apple after peeling it off in a spiral shape.

An advantage of the curved shape is that the peak force occurring during cutting is reduced, as compared to a case of a cutting edge with a transition portion having an angularity which results in a relatively large peak force. The cutting tool does not need to meet the same standards of stability as compared to using a cutting edge which has an angular transition point, e.g. a point where the leading and the trailing portions meet, as a transition portion. Therefore, one can use a material for the main body which does not need to be as rigid and stable as the main body of a cutting tool with a cutting edge having an angularity, as the peak force which needs to be sustained is not as high. In other words, the main body can be made from a material which has different advantageous properties, such as a low risk of corroding, of being light and/or which can be processed more easily or cost-efficiently. Moreover, the main body can be made of a lower cost material, such as plastic, instead of a costly metal. This also prevents corrosion of the main body, is light, and allows shaping the inside of the main body more efficiently. For example, the main body can be molded so as to merely have smooth structures on the inside, so as not to break a cutting chip entering the accommodation space.

The leading and the trailing portions of the cutting edge can be substantially straight. For example, the leading portion can extend substantially parallel to the opening, through which a cutting chip may be received in the accommodation space. This configuration is advantageous, as it promotes the production of a single-piece cutting chip. It may also promote cutting off a spirally shaped cutting chip, by rotating the cutting tool around a central axis. The trailing portion may extend substantially parallel to a part of the main body, or it may be tapered inwardly with regard to an adjacent part of the main body. The tapering may hence be oriented such that it extends in a radially inward direction of the main body with increasing distance from the tip of the tool, i.e. with increasing distance from the geometrical apex of the tapered part of the main body.

Preferably, the transition portion is a continuous extension of the leading portion. The continuity is intended to express that the lie on the same edge, i.e. the cutting edge. In other words, the transition between the transition portion and the leading portion is preferably without any angularity. For example, the two portions may be oriented in the same direction. Likewise, also the trailing portion may be an extension of the transition portion, so that all three portions may be continuous with one another, as if they were to be understood to lie on one and the same cutting edge of a knife.

Preferably, the leading portion and the transition portion are configured such that a cutting zone, being a part of the cutting edge where a contact between the cutting edge and a pipe to be cut is established and the actual cutting is effected, may continuously move from the leading portion to the transition portion. The cutting zone may hence be dynamic, in the sense that the region where the cutting zone is formed may not always be the same region of the cutting edge, but the region may wander along the cutting edge. In other words, when the cutting tool is used, the cutting zone may first lie on the leading portion and may move along the leading portion in a direction towards the transition portion. At some point, the cutting zone may reach the transition portion, so that it may partially lie on the leading portion and partially on the transition portion. Eventually, the cutting zone may then exclusively lie on the transition portion.

According to a preferred embodiment, the curvature radius of the transition portion exceeds a predetermined threshold value. The curvature radius of the transition portion may be constant or it may vary. If it varies, it is preferably held above the predetermined threshold value throughout the entire transition portion.

Keeping the curvature radius above the predetermined threshold value allows keeping the maximal peak force exerted when cutting below some threshold. The threshold value is preferably related to the size (diameter) of a hole to be S formed in a pipe and may amount to a quarter of the diameter of the hole. For example, when a hole with a diameter of e.g. 10 mm or 200 mm is to be formed, the curvature radius preferably exceeds 2.5 mm or 50 mm, respectively. In any case, the threshold value is significantly larger than a curvature radius of an angularity in a blade of e.g. 0.5 mm or 1.0 mm, which may be a necessary by-product of the production process used for the blade such as stamping sheet metal, grinding a knife angle and machining a particular geometry. In this regard, a curvature radius of 1.0 mm or less may be neglected, so that a corner in a blade with such a small curvature radius is simply regarded to be an angularity without any curvature radius. Even more preferably, the curvature radius may lie in a range of between a quarter and three times the diameter of a hole to be formed. When a hole with a diameter of e.g. 10 mm or 200 mm is to be formed, the curvature radius throughout the transition portion may hence lie in a range of 2.5 to 30 mm, or of 50 mm to 600 mm, respectively.

It is also preferable when the cutting edge is configured as a cutting blade. For example, a cutting blade can be chosen from a material suitable to cut PVC. The cutting may also involve starting the cutting, and may for example include peeling, piercing, drilling and/or milling.

Preferably, the cutting tool is configured to cut and/or peel off a layer of a fluid transportation pipe while rotating around a central axis of the tool.

When the cutting tool is brought into contact with a fluid transportation pipe, and the tool is rotated around a central axis, e.g. the central axis of the main body, the cutting edge of the tool may sweep over one or several layers of the pipe and cut, peel or scrape off a single-piece cutting chip. The single-piece cut off cutting chip may be a spirally shaped cutting chip. The cutting piece may also have a different shape. This shape can be influenced by altering the design of the tool, for example by changing the shape and form of the tapered part.

When combining the configuration to cut and/or peel off a layer of a fluid transportation pipe while rotating around a central axis of the tool with a cutting edge having a transition portion with a curvature radius exceeding a predetermined threshold value, it is especially advantageous to choose the length of the leading portion of the cutting tool such that the transition portion is involved in cutting after a predetermined number of turns of the tool. This can be done by choosing a particular length for the leading portion of the cutting edge. For example, the transition portion may effect the separation between a cutting chip and a pipe being cut after between 15 and 25 turns of the tool, or preferably between 18 and 22, or even at around 20 turns of the cutting tool.

According to an embodiment, the main body is a cylindrical body. In this case, the cutting tool may be configured to cut a layer of a pipe while rotating around a central axis of the cylindrical body. This is advantageous, as this promotes the generation of a single-piece cutting chip, for example a spiral shaped cutting chip.

Preferably, the tapered part is at least partially cone-shaped. In this case, the geometrical apex of the tapered part may be the geometrical apex of a cone.

According to a preferred embodiment, the cylindrical body and/or the tapered part are/is made of plastic and the cutting edge is made of metal. A cylindrical body and/or a tapered part made from plastic are/is advantageous, as this reduces the manufacturing costs of the entire cutting tool. However, the implementation of a cutting edge made of metal nevertheless allows cutting through rather hard pipe materials such as PVC.

It is especially preferable when the cutting edge is made of stainless steel. Stainless steel is particularly suited to cut through hard materials of fluid transportation pipes, such as hard plastic pipes comprising or consisting of PVC.

It is preferable when the tapered part has a tapered part axis which is parallel and off-center relative to a main axis of the main body. For example, the off-center axis of the tapered part may be a cone axis. The parallel and off-center orientation of the tapered part axis promotes the prevention of the cutting tool getting stuck during the cutting process, i.e. it prevents the cutting tool getting jammed.

According to a preferred embodiment, the main body and the tapered part are a single-piece element. Put differently, the tapered part is preferably a part of the main element itself. This configuration reduces the number of seal lines and implements a single rigid piece which is resistant to high pressures. It is also advantageous, as the main body including the tapered part can be made of a particular desirable material, such as plastic, while the cutting edge can be made of a different material, such as metal (e.g. stainless steel). The main body and the tapered part are preferably made of plastic, such as polypropylene (PP), polyvinyl chloride (PVC), polyamide (PA) and/or polyoxymethylene (POM).

Preferably, the opening of the cutting tool is formed as a slot extending substantially parallel to the cutting edge. A slot includes a configuration in which the cross-section of the opening is oblong. A slot-shaped opening is advantageous, as it allows catching a cutting chip along the entire length of the slot. To this end, it is preferable for the slot to extend substantially in parallel to the cutting edge.

According to one embodiment, the accommodation space for receiving a cutting chip may be formed in the main body, in the tapered part, or in both.

Preferably, the accommodation space has a volume that is at least 3.5 times as large as the maximum volume of material that can be cut out using the cutting tool. Such a large accommodation space promotes the entry of a cutting chip without resistance, even if the cutting chip may have a single small cross section curl and even it is voluminous.

According to an embodiment of the present invention, the cutting edge is locked in its position during injection molding of the main body. Alternatively, the cutting edge may be held in place by any one or a combination of formfitting, clamp fitting, over-molding, gluing, and at least one set screw. This ensures sufficient rigidity and stability of the cutting tool, even although the cutting edge is a separately formed element with regard to the main body, and, possibly, the tapered part.

Preferably, a path for the cutting chip is free from obstacles prone to cause a fracture of a cutting chip. In this context, the path of the cutting chip is to be understood to be the path through which it enters into the accommodation space during a cutting process. Being free of obstacles is to be understood to mean, that no surfaces or other objects poke out in the pathway of a cutting chip. This minimizes the risk of a fracture of a cutting chip from occurring or stress-concentrations in the chip, such that ideally no folding of the chip occurs.

According to an embodiment of the present invention, the main body comprises a circumferential surface, and the circumferential surface includes an outer thread. The outer thread on the circumferential surface may assist a cutting process while rotating the cutting tool around a central axis. For example, the outer thread may interact with an inner thread provided in a connection branching member. In addition, the outer thread can also assist a retraction movement, wherein the cutting tool is withdrawn from a cutting position, for example in order to be withdrawn into a storage space provided in a branching connection member.

A cutting blade according to an aspect of the present invention is suited to be used with a cutting tool according to any one of the previously described aspects of the present invention. The cutting blade comprises a leading portion, extending to a position close to the geometrical apex of the tapered part, a trailing portion, and a transition portion, located between the leading portion and the trailing portion, for effecting a separation between a cutting chip and a pipe being cut, wherein the transition portion has a curved shape. Preferably, a curvature radius of the transition portion exceeds a predetermined threshold value. Reference is made to the technical advantages associated with embodiments of cutting edges described earlier on.

A branch connection device according to an aspect of the present invention comprises a T-shaped connection element with a main part and a branching pipe connection part. For example, the main part may be at least partially cylindrically shaped, and the branching pipe connection part may be located on the side of the main part. However, the present invention is not limited thereto. The branching pipe connection device may extend perpendicularly or obliquely with regard to the main part.

The main part comprises a mounting end portion for mounting the device on a pipe from which a branch is to be branched-off and configured to fluidly connect the main part with a pipe from which a branch is to be branched-off.

In addition, the main part comprises a cutting tool according to any one of the embodiments described above. The cutting tool may, at least at times, be received in the main part of the branch connection device.

The main part further comprises a storage space for receiving and storing the cutting tool, wherein the cutting tool is retractable from a cutting position for cutting a pipe, from which a branch is to be branched-off at the mounting end portion, into the storage space. The branching pipe connection part is fluidly connected to the main part between the storage space and the mounting end portion.

The branch connection device is advantageous, as it allows to perform a cutting process and to then simply withdraw the cutting tool with a cutting chip stored in the accommodation space into the storage space. This promotes a higher efficiency, and the use of the single-use cutting tools with a branch connection device of this pipe is more cost-effective than known techniques to form a branching point on a pipe in use.

The present invention further comprises a branch connection device for a pipe, comprising a T-shaped connection element with a main part and a branching pipe connection part. The main part comprises a mounting end portion for mounting the device on a pipe from which a branch is to be branched-off and configured to fluidly connect the main part with a pipe from which a branch is to be branched-off. The main part further comprises a cutting tool and a storage space for receiving and storing the cutting tool. The cutting tool is retractable from a cutting position for cutting a pipe from which a branch is to be branched-off at the mounting end portion into the storage space. Additionally, the branching pipe connection part is fluidly connected to the main part between the storage space and the mounting end portion. Moreover, the cutting tool is configured to cut PVC.

Such a branch connection device may be used to form a branching point in a fluid transportation pipe such as a water transportation pipe comprising or consisting of PVC (polyvinyl chloride).

Preferably, any one of the previously described branch connection device may be configured such that the main part is provided with an inner thread and the cutting tool is provided with an outer thread. These inner and outer threads are configured to interact in order to assist a retraction movement of the cutting tool from the cutting position into the storage space and/or to assist a cutting process of the cutting tool.

Additional advantages and features of the present invention, that can be realized on their own or in combination with one or several features discussed above, insofar as the features do not contradict each other, will become apparent from the following description of preferred embodiments.

### BRIEF DESCRIPTION OF THE DRAWINGS

The description is given with reference to the accompanying drawings, in which:

FIGS. 1A and 1B are perspective views of an embodiment of a cutting tool according to the present invention;

FIGS. 2A is a sectional view of an embodiment of a cutting tool according to the present invention; FIGS. 2B is a top view of the embodiment of a cutting tool depicted in FIG. 2A;

FIG. 3A is a side view of an embodiment of a cutting tool according to the present invention; FIG. 3B is a sectional view through the embodiment of a cutting tool shown in FIG. 3A, as seen in the direction of the arrows A in FIG. 3A; FIG. 3C is an enlarged view of a part B of FIG. 3B;

FIG. 4A is a perspective view of an embodiment of a cutting tool according to the present invention; FIG. 4B is a perspective view of a different embodiment of a cutting tool;

FIG. 5 is a comparative view of a torque as occurring with a cutting tool shown in FIG. 4A, and as occurring with a cutting tool shown in FIG. 4B, in function of the turns of the cutting tool;

FIG. 6 depicts top and bottom views as well as left and right side views of broad and narrow sides of an embodiment of a cutting blade according to the present invention;

FIGS. 7A and 7B are perspective view of an embodiment of a cutting blade according to the present invention; FIG. 7C is a side view of the cutting blade depicted in FIGS. 7A and 7B; and

FIG. 8A is a perspective view of an embodiment of a branch connection device according to the present invention without a cutting tool, and FIG. 8B is a perspective view of the same embodiment of a branch connection device comprising a cutting tool.

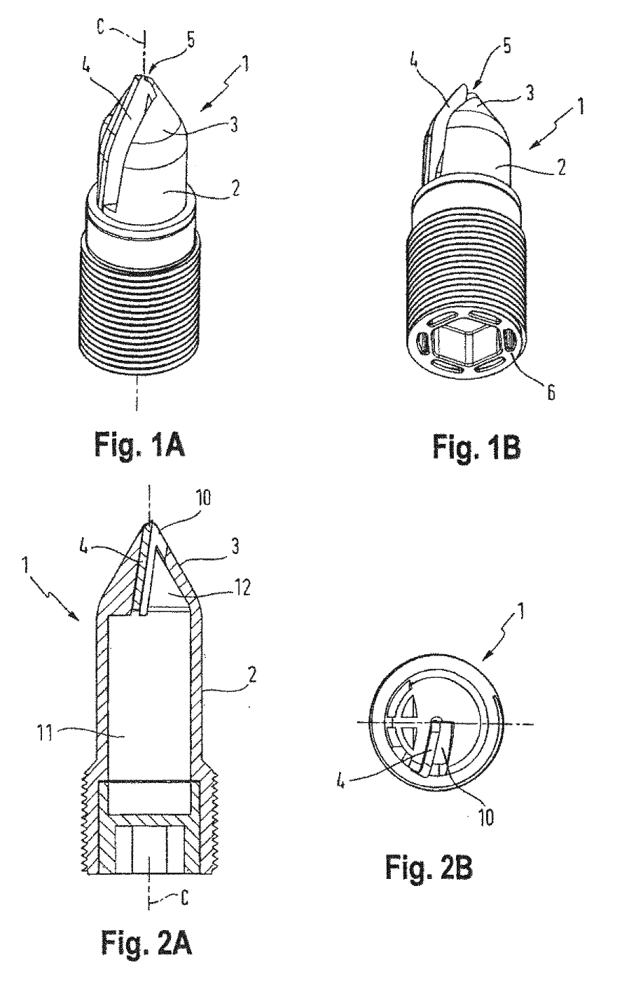

FIGS. 1A and 1B are perspective views of an embodiment of a cutting tool according to the present invention.

The cutting tool 1 is configured to cut a hole into a fluid transportation pipe and to retain a cutting chip as produced by the cutting process. It comprises a main body 2 having an end which is prolonged by a tapered part 3. The tapered part 3 extends towards the tip of the tool 1.

The tool 1 further comprises a cutting blade, which forms a cutting edge 4, extending from the geometrical apex 5 of the tapered part 3 to the periphery of the main body 2. In this context, an extension from the geometrical apex 5 does not imply that the tip of the cutting edge 4 needs to precisely be positioned at the geometrical apex 5, but it means that the cutting edge 4 extends up to a vicinity of the geometrical apex 5. In the case of the embodiment of FIGS. 1A and 1B, the distance between the tip of the cutting edge 4 and the geometrical apex 5 amounts to a few mm, but the present invention encompasses embodiments wherein the distance takes on any preferred value, such as e.g. 0 to 3 cm, or between 0.2 and 0.5 mm. The cutting edge 4 may be provided by a cutting blade. However, it is not inconceivable that the cutting edge is provided as a coating or a sheet of material, such as thin metal, applied to a supporting part of the main body.

In the case of the embodiment depicted in FIGS. 1A and 1B, the main body 1 is made of plastic, while the cutting edge 4 is made of stainless steel. In other words, the material of the main body 2 (plastic) differs from the material of the cutting edge 4 (stainless steel). However, the present invention also encompasses embodiments wherein at least one of the main body 1 and the cutting edge 4 is made from a different material. For example, the cutting edge 4 can be made from any chosen metal, wherein said metal can be chosen such that it can cut a chosen type of fluid transportation pipe.

As can be seen in FIG. 1B, this embodiment of a cutting tool 1 also comprises a mounting part 6 for mounting the cutting tool 1 e.g. on an actuator exerting a rotational force onto the cutting tool 1. Accordingly, the embodiment of a cutting tool according to the present invention displayed in FIGS. 1A and 1B is configured to cut and/or peel off a layer of a fluid transportation pipe, such as a PVC water transportation pipe, while rotating around a central axis C of the tool 1.

In the case of the embodiment shown in FIGS. 1A and 1B, the main body 1 is a cylindrical body and the tapered part 3 is cone-shaped, but the present invention is not limited thereto.

FIG. 2A is a sectional view of an embodiment of a cutting tool 1 according to the present invention, and FIG. 2B is a top view of the embodiment of the cutting tool 1 depicted in FIG. 2A.

As can be seen from FIG. 2A, the tapered part 3 and the main body 2 are, in the case of this embodiment, a single-piece element. This is advantageous, as this configuration reduces the number of seal lines and may provide a single entity rigid element which is resistant to high pressures.

FIG. 2A illustrates that the inside of the cutting tool 1 is provided with an accommodation space 11 for receiving via an opening 10 a cutting chip as produced during a cutting process on a pipe. The opening 10 extends substantially in parallel to a leading (tip side) portion of the cutting edge 4.

When the cutting tool 1 of FIGS. 2A and 2B is rotated around its central axis C, the cutting edge 4 may drill into an outer layer of a fluid transportation pipe and start peeling off a cutting chip in a spiral shape, by virtue of the rotation of the cutting tool 1. The single piece cutting chip enters the opening 10, positioned adjacent to the cutting edge 4, and is thereby guided into the accommodation space 11. This is further promoted as the opening 10 is formed as a slot, extending substantially parallel to a leading portion of the cutting edge 4.

In the case of the cutting tool of FIG. 2A, the accommodation space 11 is mainly formed inside of the main body 2, but there is also a part 12 of the accommodation space 11 which is located in the tapered part 3.

The accommodation space 11 of the embodiment of the cutting tool depicted in FIGS. 2A and 2B has a volume which is more than 3.5 times as large as the maximum volume of cutting chip material which can be cut out using this cutting tool 1.

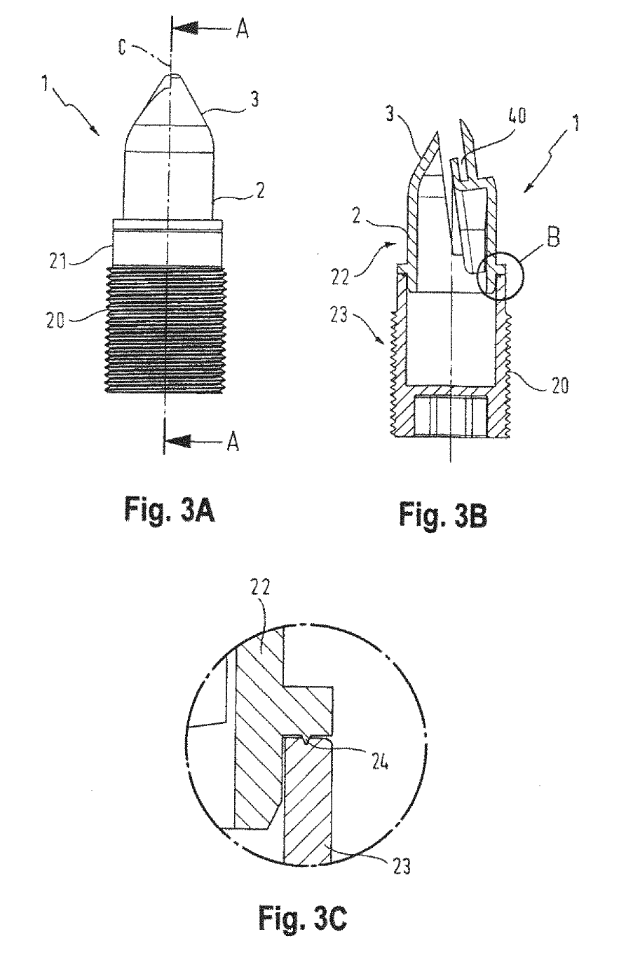

FIG. 3A is a side view of an embodiment of a cutting tool according to the present invention. FIG. 3A again displays a main part 2 and a tapered part 3. Moreover, a lower part of the main part 2 is provided with a circumferential surface 21 comprising, at a lower part thereof, an outer thread 20. The outer thread 20 may assist a cutting process while rotating the cutting tool 1 around its central axis C. The outer thread 20 may interact with an inner thread (not shown), provided in a connection branching member, also referred to as a saddle, which may be used together with a cutting tool according to the present invention.

On the one hand, the outer thread 20 may interact with such an inner thread (not shown) during the cutting process, but it may also, on the other hand, assist a retraction movement, wherein the cutting tool 1 is withdrawn from a cutting position, for example in order to be withdrawn into a storage space provided in a branching connection member provided with the cutting tool 1.

FIG. 3B is a sectional view along the central axis C of the cutting tool 1 depicted in FIG. 3A, as viewed in the direction of the arrows A in FIG. 3A. FIG. 3B shows the cutting tool 1 without a cutting edge. A mounting space 40 for receiving the cutting edge is provided towards the tip of the tool 1, i.e. at the tapered part 3. Moreover, FIG. 3B shows that the displayed embodiment of a cutting tool 1 comprises a main body 2 which is formed of two components, an upper component 22, and a lower component 23, The outer thread 20 is provided on a circumferential surface 21 of the lower component 23.

As can be seen best in the enlarged view of part B of FIG. 3B, the upper component 22 and the lower component 23 are fit together by means of a protrusion 24 provided on the upper component 22, which is received in a corresponding recess provided in the lower component 23, so as to form a press fit connection. Additionally, the upper and lower components 22, 23 of this embodiment may be welded together. The advantage of such a configuration lies in a simplification of the manufacturing process, as the upper part of the main body 2 can be separately processed in order to provide a suitable opening 10 for receiving a cutting chip and a mounting space for a cutting edge, whereas also the lower part of the main body 2 can be separately processed, in order, for example, to provide the outer thread 20.

A cutting edge can be inserted into the mounting space 40 depicted in FIG. 3B, and it can be fixed by a set screw, glued to the main body 2, or it may be held in place by a formfitting or clamp fitting. Another option to form a cutting edge consists of over-molding it onto the main body 2 of the cutting tool 1.

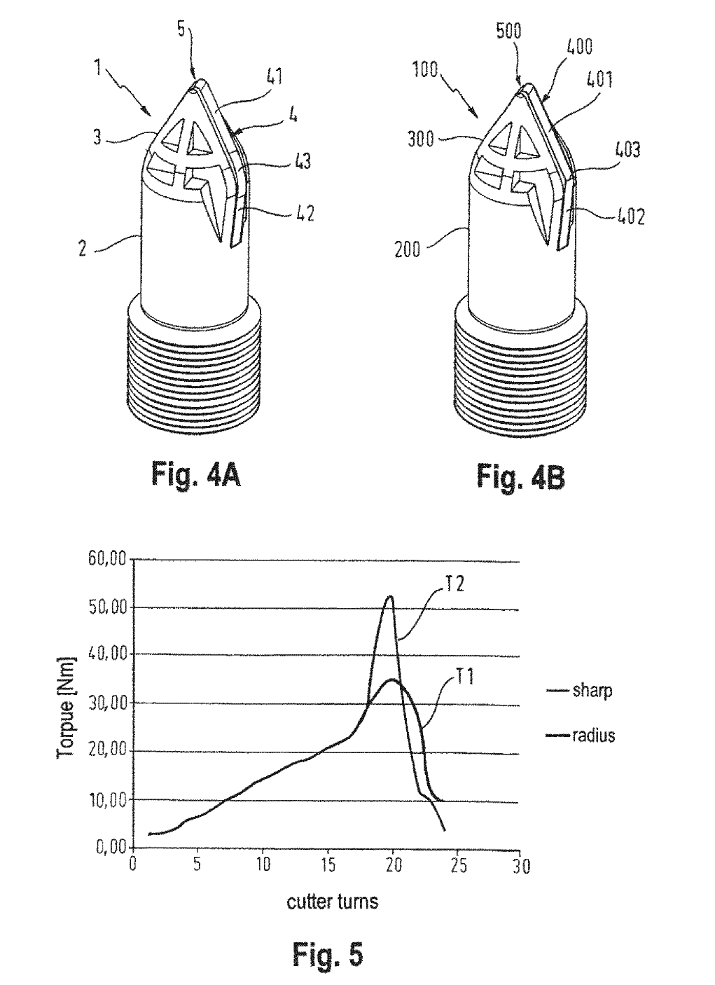

FIG. 4A is a perspective view of an embodiment of a cutting tool 1 according to the present invention. The cutting edge 4 of the embodiment depicted in FIG. 4A has a leading portion 41, extending to the geometrical apex 5 of the tapered part 3 of the main body 2, a trailing portion 42, and a transition portion 43, located between the leading portion 41 and the trailing portion 42. The transition portion 43 is the portion of the cutting edge 4 provided for effecting a final separation between a cutting chip and a pipe being cut. The transition portion 43 has a curved shape.

For comparison, FIG. 4B depicts an embodiment of a cutting tool 100 with a cutting edge 400, comprising a leading portion 401, extending to the geometrical apex 500 of the tapered part 300 of the main body 200, the trailing portion 402, and a transition portion 403, located between the leading portion 401 and the trailing portion 402, for effecting a (final) separation between a cutting chip and a pipe being cut. In contrast to the transition portion of the embodiment of FIG. 4A, the transition portion 403 of the cutting tool 100 of FIG. 48 is angular. An advantage of curved transition portion 43 in FIG. 4A over an angularly shaped transition portion 403 in FIG. 4B, is that the peak force experienced by the corresponding cutting tool (in FIG. 4A) is reduced.

The highest forces occurring during the cutting, which may take place during the (final) separation of a cutting chip from a pipe, are distributed due to the curved shape of the transition portion 43, and hence spread out over a larger number of turns of the cutting tool 1. Therefore, the peak force is also reduced, and the cutting tool 1 does not need to comprise a main body 2 of the same rigidity as a main body 200 of the cutting tool 100, depicted in FIG. 4B. Consequently, the main body 200 of the cutting tool 100 in FIG. 4B is made of metal, while the main body 2 of the cutting tool 1 of FIG. 4A is made of plastic, which is rigid and stable enough for the entire cutting tool 1 to be able to support the reduced peak force occurring. Therefore, the cutting tool of FIG. 4A can be produced more cost efficiently than the cutting tool 100 of FIG. 4B.

FIG. 5 illustrates the difference between the peak forces occurring during use of the cutting tools depicted in FIGS. 4A and 4B, for comparison. FIG. 5 is a functional plot of the torque force, measured in Nm, applied with the cutting tool upon contacting and cutting a fluid transportation pipe, in function of the number of turns of the cutting tool. In both cases, contact with a pipe to be cut is established in the vicinity of the first turn of the tool, and the torque then continuously increases up until about 17 turns. At this stage, the torques applied by the cutting tools 1 and 100 of FIGS. 4A and 4B, respectively, differ.

The curve T1 depicts the torque applied using the cutting tool 1 with a curved transition portion 43 (FIG. 4A). While the torque remains increasing just after the 17^{th} cutter turn, it does not increase as much as the torque applied by virtue of the cutting tool 100 comprising a sharp edge transition portion 403 (FIG. 4B), depicted as the curve T2. The peak force in the curve T1 of the cutting tool 1 of FIG. 4A amounts to about 34 Nm, whereas the peak force applied using the cutting tool 100 of FIG. 4B in curve T2 amounts to about 53 Nm. Thus, the cutting tool 100 with the sharp edged transition portion 403 must sustain higher forces than the cutting tool 1 of FIG. 4A, and must therefore comprise a main body 200 made from more stable and rigid (and costly) material, such as metal, than the main body 2 of the cutting tool 1 in FIG. 4A which may be made of plastic.

The peak force occurs in the curves T1 and T2 in FIG. 5 the transition portions 43 and 403, respectively, engage in a separation of a cutting chip from a pipe being cut out, i.e. approximately after 19 cutter turns.

The radius of curvature of the transition portion 43 of the cutting tool 1 displayed in FIG. 4A stays above a predetermined threshold value. This ensures that the peak force (the highest point in the curve T1 of the torque experienced by the cutting tool 1 of FIG. 4A) stays below a predetermined peak torque value. In this way, the material of the main body 2 of the cutting tool 1 can be matched with a certain minimal radius of curvature of the transition portion 43 of the cutting edge 4 used for the separation between a cutting chip and a pipe being cut.

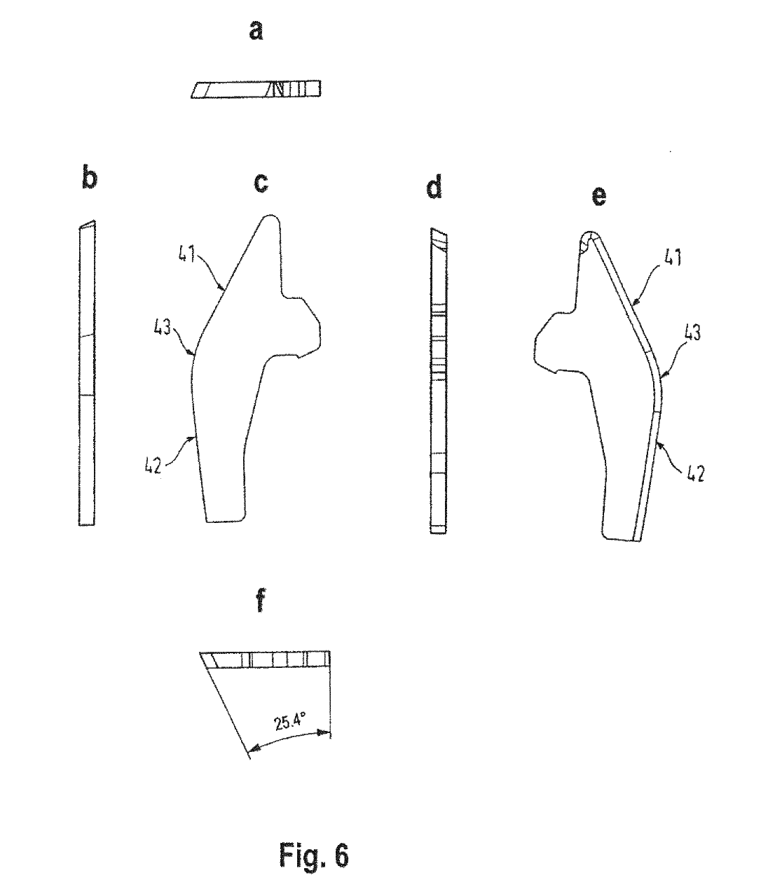

FIG. 6 depicts six different views of an embodiment of a cutting blade according to the present invention. Part a of FIG. 6 depicts a top view of the cutting blade 4; part b depicts a side view of a thin side of the cutting blade 4, whereas part d depicts a side view of an opposite thin side; part c depicts a left side view of a broad side of the cutting blade 4, whereas part e depicts a side view of the opposite broad side of the cutting blade 4; and part f depicts a bottom view of an embodiment of the cutting blade 4 according an embodiment of the present invention.

As the various views of FIG. 6 illustrate, the cutting blade 4 is chamfered along the entire side, at an angle close to 25.4°, as depicted in part f of FIG. 6. Moreover, parts c and e of FIG. 6 depict the leading portion 41, the trailing portion 42 and the intermediate portion 43 of the cutting blade 4, wherein the intermediate portion 43 has a curved shape. Specifically, the radius of curvature of the intermediate portion 43 exceeds a predetermined threshold value, for the same reasons as explained previously with regard to the cutting edge 4 depicted in FIG. 4A.

The embodiment of a cutting blade depicted in FIG. 6 is configured to be at least partly received in a mounting opening 40 of the embodiment of a cutting tool 1 as depicted in FIG. 3B.

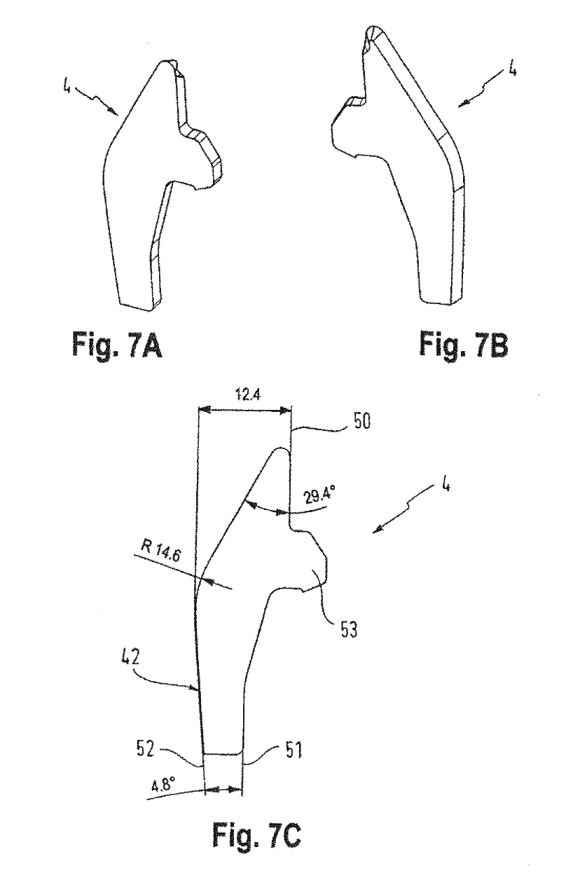

FIGS. 7A and 7B depict further perspective views from the left and the right side of the embodiment of a cutting blade 4 according to the present invention depicted in FIG. 6.

FIG. 7C is a further side view of the embodiment of a cutting blade 4 according to the present invention depicted in FIGS. 6, 7A and 7B. When the embodiment of the cutting blade 4 of FIG. 7C is arranged in a cutting tool, it is mounted in a position wherein the line 50 extends substantially in parallel to the central axis C of the cutting tool 1. As will become apparent from FIG. 7C, the lines 51 and 52 are not entirely parallel, but the trailing portion 42 of the cutting blade 4 is slanted in a radially inward direction. This corresponds to the fact that the lines 51 and 52 define an angle close to 4.8°. The front end part of the circumferential surface of the cutting blade 4 covers an angle close to 29.4°.

Moreover, the cutting blade 4 comprises a mounting protrusion 53 which can be held firmly inside of the main body of a corresponding cutting tool.

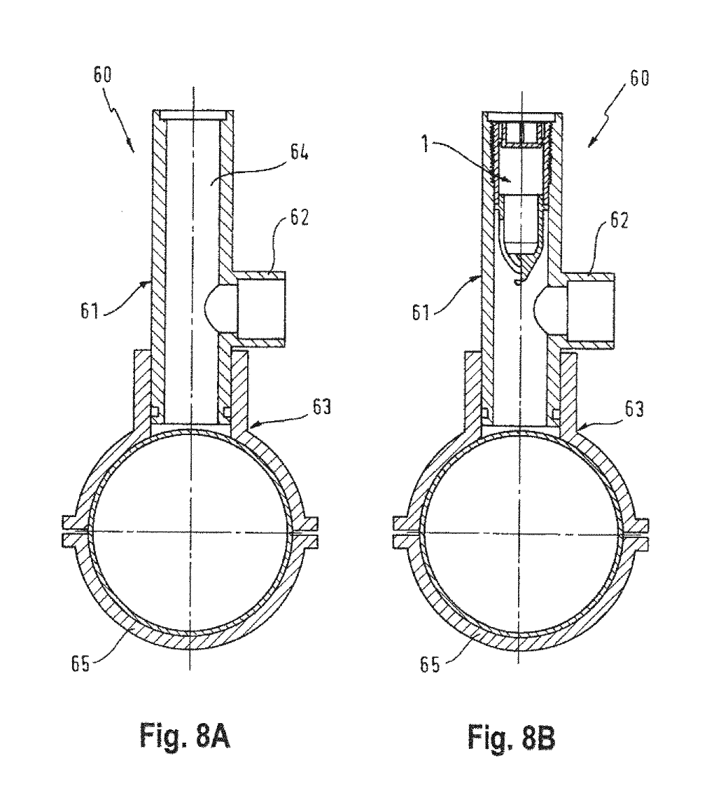

FIG. 8A depicts a perspective view of an embodiment of a branch connection device 60 for a pipe, also referred to as a saddle. FIG. 8B is another image of the same embodiment of a branch connection device, but this time comprising a cutting tool 1.

The branch connection device 60 may be used to branch off an additional pipe from a fluid transportation pipe already transporting a fluid and already installed in place. For example, the branch connection device 60 can be used to branch off a pipe from a water transportation pipe made from PVC and already mounted in a building or underground. Specifically, the branch connection device 60 can be used to branch off an additional pipe without interrupting the fluid transportation in the pipe in use and without, for example, having to depressurize the pipe in use, in order to implement a branching point.

The branch connection device 60 comprises a T-shaped connection element with a main part 61 and a branching pipe connection part 62. The branching pipe connection part 62 is configured to be connected with a branching pipe, being a further pipe which is branched off from the pipe already in use.

The main part 61 comprises a mounting end portion 63 which is configured to mount the device 60 onto a pipe from which a branch is to be branched-off and which is configured to fluidly connect the main part 61 with a pipe in use. In the case of the embodiment depicted in FIGS. 8A and 8B, the mounting end portion 63 comprises mounting ring 65 which is configured to be fit around a fluid transportation pipe. The mounting ring 65 has two parts and can be disassembled, the parts can be fit to a pipe and then fastened together, to bring the branch connection member 64 into position.

A cutting tool 1 is arranged in the main part 61, as depicted in FIG. 8B, and the cutting tool 1 can be used to drill into the fluid transportation pipe in use, and to cut out a part of the layers of the pipe in use, while concurrently the internal fluid pressure is maintained. To perform the cutting process, the cutting tool (not shown in FIG. 8A) is rotated around its central axis inside of the main part 61 of the branch connection device 60, and a spirally shaped cutting chip is thereby cut out of the pipe in use.

To assist the cutting movement, the cutting tool is provided with an outer thread, as displayed e.g. for the embodiment of the cutting tool 1 depicted in FIG. 3A. Although this is not the case for the embodiment depicted in FIGS. 8A and 8B, an inner periphery of a part of the mounting end portion 63 of the main part 61 of the branch connection device 60 (the part located above of the mounting ring 65 in FIGS. 8A and 8B) may be provided with an inner thread. Such an inner thread may be configured to interact with the outer thread 20 of the cutting tool 1, in order to assist the cutting movement.

The cutting chip, which is formed in a single piece, is received via the opening 10 of the cutting tool 1 and is stored in the accommodation space 11. When the cutting process is complete, the cutting tool 1 can be withdrawn from the cutting position located towards the mounting end portion 63. The outer thread of the cutting tool and the inner thread on the inside periphery of a part of the main part 61 of the branch connection device 60 interact to assist the retraction movement, in order to withdraw the cutting tool 1 from the cutting position.

The main part 61 of the branch connection device 60 comprises a storage space 64 for receiving and storing the cutting tool 1 after use. The cutting tool is hence retractable from the cutting position into the storage space 64.

The branching pipe connection part 62 is fluidly connected to the main part 61 at a position between the storage space 64 and the mounting end portion 63. Thus, the cutting tool 1 is not in the way of the established fluid connection between the pipe, from which a pipe is branched off, and the branching pipe connection part 62. In this way, the cutting tool 1 can be withdrawn into a position where it can remain long term, i.e. the storage space 64.

In the case of the embodiment of a branch connection device depicted in FIGS. 8A and 8B, the cutting chip is stored in the accommodation space 11 of the cutting tool 1, whereas the cutting tool 1 is stored in the storage space 64 after use, where it can remain for an extended period of time such as, for example, 50 years. In this regard, the branch connection device and the cutting tool according to the present invention are very convenient, as the cutting tool does not need to be extracted from the branch connection device after use, and the cutting chip does also not need to be disposed. The entire process of branching off a pipe from a pipe in use is thereby simplified and made cost-efficient.

Due to the fact that the cutting tool can be made from a cheap material, such as for example plastic, it is also cost efficient to merely use a cutting tool once, and to then simply leave it behind in a branch connection device after the branching-off of an additional pipe from the pipe in use is completed.

Many additional variations and modifications are possible and are understood to fall within the framework of the invention.

1. A cutting tool for cutting a hole into a fluid transportation pipe and for retaining a cutting chip,
the tool comprising a main body having an end which is prolonged by a tapered part, the tool further comprising an accommodation space, the tool being configured to receive a cutting chip in the accommodation space via an opening which extends at least from a geometrical apex of the tapered part to the periphery of the main body,
the tool further having a cutting edge extending at least from the geometrical apex of the tapered part to the periphery of the main body of the cutting tool,
wherein the main body is made of a material that differs from a material of which the cutting edge is made.

2. A cutting tool according to claim 1, wherein the cutting edge comprises: a leading portion which extends from a position close to the geometrical apex of the tapered part of the main body; a trailing portion; and a transition portion which is located between the leading portion and the trailing portion, for effecting a separation between a cutting chip and a pipe being cut, wherein the transition portion has a curved shape, wherein a curvature radius of the transition portion preferably exceeds a predetermined threshold value.

3. (canceled)

4. A cutting tool according to claim 1, wherein the cutting tool is configured to cut and/or peel off a layer of a fluid transportation pipe while rotating around a central axis of the tool.

5. A cutting tool according to claim 1, wherein the main body is a cylindrical body and/or the tapered part is at least partially cone-shaped, wherein the main body and/or the tapered part is preferably made of plastic, and the cutting edge is preferably made of metal, preferably of stainless steel.

6. (canceled)

7. A cutting tool according to claim 1, wherein the tapered part has a tapered part axis which is parallel and off-center relative to a main axis of the main body.

8. A cutting tool according to claim 1, wherein the main body and the tapered part are a single-piece element.

9. A cutting tool according to claim 1, wherein the opening is formed as a slot extending substantially parallel to the cutting edge.

10. A cutting tool according to claim 1, wherein the accommodation space is formed in the main body and/or in the tapered part.

11. (canceled)

12. A cutting tool according to claim 1, wherein the cutting edge is held in place by any one or a combination of: formfitting, clamp fitting, over-molding, gluing, and at least one set screw.

13-14. (canceled)

15. A cutting tool according to any one of the previous claims, wherein the main body includes a circumferential surface, and the circumferential surface comprises an outer thread.

16. Use of a cutting tool according to claim 1 to cut a fluid transportation pipe comprising PVC.

17. Cutting blade for a cutting tool according claim 1, wherein the cutting blade comprises: a leading portion, extending from a position close to the geometrical apex of the tapered part, a trailing portion, and a transition portion, located between the leading portion and the trailing portion, for effecting a separation between a cutting chip and a pipe being cut, wherein the transition portion has a curved shape.

18. (canceled)

19. Branch connection device for a pipe, comprising a T-shaped connection element with a main part and a branching pipe connection part, the main part comprising a mounting end portion for mounting the device on a pipe from which a branch is to be branched-off and configured to fluidly connect the main part with a pipe from which a branch is to be branched-off,
the connection element further comprising a cutting tool according to claim 1,
and a storage space for receiving and retaining the cutting tool,
wherein the cutting tool is retractable from a cutting position for cutting a pipe from which a branch is to be branched-off at the mounting end portion into the storage space, wherein the branching pipe connection part is fluidly connected to the main part between the storage space and the mounting end portion.

20. Branch connection device for a pipe, comprising a T-shaped connection element with a main part and a branching pipe connection part, the main part comprising a mounting end portion for mounting the device on a pipe from which a branch is to be branched-off and configured to fluidly connect the main part with a pipe from which a branch is to be branched-off,
the main part comprising a cutting tool and a storage space for receiving and storing the cutting tool, and
wherein the cutting tool is retractable from a cutting position for cutting a pipe from which a branch is to be branched-off at the mounting end portion into the storage space, wherein the branching pipe connection part is fluidly connected to the main part between the storage space and the mounting end portion, and wherein the cutting tool is configured to cut PVC.

21. Branch connection device according to claim 19, wherein the main part is provided with an inner thread and the cutting tool is provided with an outer thread, said inner and outer threads configured to interact in order to assist a retraction movement of the cutting tool from a cutting position into the storage space and/or a cutting process of the cutting tool.
